(19) United States
(12) Patent Application Publication
(10) Pub. No.: US 2009/0150272 A1
(43) Pub. Date: Jun. 11, 2009

(54) Graphical Representation of Financial Transactions

(75) Inventor: Simon Blythe, Ely (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/952,409

(22) Filed: Dec. 7, 2007

(51) Int. Cl. G06Q 40/00

(52) U.S. Cl. 705/35

(57) ABSTRACT

A statement generator allows financial institutions to present transaction information as a graphical representation to an account holder in, for example, a statement of purchases. The statement generator obtains transaction information associated with an account holder and maps the transaction information to correlate the transaction information with at least one parameter. The transaction information can include at least one of a purchase amount, a purchase location, a purchase time, or a purchase category. The at least one parameter includes at least one of a purchase location, a purchase time, a purchase amount, or a purchase category. The statement generator depicts the mapping to the account holder to identify a correlation between transactions. The depiction can be a print out of the mapping or the mapping can be rendered on a display.

### BACKGROUND

In recent years, non-cash transactions have become a preferred method of payment for consumers. Such transactions can use transaction devices, such as credit cards or debit cards. These types of transactions, however, increase the opportunity for unauthorized and/or fraudulent usage of transaction devices or accounts associated with the transaction devices.

Credit cards allow consumers to engage in financial transactions with a participating merchant without a present requirement of money from the consumer. In a typical credit card transaction, the participating merchant receives payment from a financial institution that has agreed to allow the consumer to make purchases on credit with the promise to pay the financial institution the purchase amount plus some calculated interest at a later time. To qualify for this credit, the consumer applies for an account with the financial institution associated with the credit card. The consumer receives a credit limit of a specified dollar amount and can use the card to make purchases from participating merchants until they reach this credit limit. The financial institution in turn keeps a record of the financial transactions of the consumer and sends the consumer a statement, typically monthly, that includes a list of purchases. The list of purchases can include the purchase date, purchase amount, merchant name, and the location of the merchant.

Debit cards function in a similar manner as credit cards, but instead of drawing on credit, the consumer draws against money deposited with a financial institution, usually a financial institution with which the consumer has a bank account. Like the statements provided for credit cards, a statement that includes debit card activity is sent to the consumer to allow the consumer to review financial transactions during a given period. The statement can present the financial transactions associated with a debit card as a list of purchases in the same manner as the list of purchases in a credit card statement.

The list of purchases included in the statement allows the customer to review their credit card activity for any discrepancies for the period reflected by the statement. Such discrepancies may result from unauthorized and/or fraudulent purchases made by someone other than the consumer. Unfortunately, many such unauthorized and/or fraudulent purchases are undetected by the consumer who may not diligently review the statement. In addition, as the number of purchases increases in the list of purchases, it may be difficult for the purchaser to sort through the purchases made or to remember which purchases the consumer made and which purchases were unauthorized or fraudulent.

Therefore an improved implementation that allows consumers to readily identify unauthorized and/or fraudulent transactions associated with a statement is desired.

### SUMMARY

In one embodiment a method of presenting transaction information is disclosed. The method includes obtaining transaction information associated with an account holder and correlating the transaction information to at least one parameter. The method also includes depicting the correlation graphically to the account holder to identify a correlation between transactions.

In another embodiment, a computer readable medium that holds instructions executable by a computing device to perform graphical representation of financial transaction is disclosed. The graphical representation is performed by obtaining transaction information associated with an account holder, correlating the transaction information to at least one parameter, and depicting the correlation graphically to the account holder to identify a correlation between transactions.

In yet another embodiment, a system for generating a graphical representation of financial transaction is disclosed. The system includes storage and a statement generator. The storage stores at least one of transaction information associated with an account holder or at least one parameter. The statement generator generates a graphical representation based on the transaction information associated with an account holder and the at least one parameter. The statement generator correlates the transaction information to the at least one parameter and depicts the correlation graphically to the account holder to identify a correlation between transactions.

The transaction information can include at least one of a purchase amount, a purchase location, a purchase time, or a purchase category. The at least one parameter includes at least one of a purchase location, a purchase time, a purchase amount, or a purchase category. The depiction can be a print out of the correlation or the correlation can be rendered on a display.

The preferred embodiments of the present invention, as well as other objects, features and advantages of the present invention will be apparent from the following detailed description, which is to be read in conjunction with the accompanying drawings. The scope of the invention will be pointed out in the claims

### BRIEF DESCRIPTION OF THE DRAWINGS

FIG. 1 depicts an exemplary financial transaction system in accordance with preferred embodiments of the present invention;

FIG. 2 is a flow chart that illustrates a preferred implementation in accordance with preferred embodiments of the present invention;

FIG. 3A depicts a financial institution terminal for implementing the preferred embodiments of the present invention;

FIG. 3B depicts a distributed system for implementing the preferred embodiments of the present invention;

FIGS. 4A-B are exemplary graphical representations of a statement of purchases that can be generated in accordance with the preferred embodiments of the present invention;

FIG. 5 is another graphical representation of a statement of purchases that can be generated in accordance with the preferred embodiments of the present invention; and

FIG. 6 is yet another graphical representation of a statement of purchases that can be generated in accordance with the preferred embodiments of the present invention.

### DETAILED DESCRIPTION OF PREFERRED EMBODIMENTS

The preferred embodiments are directed to presenting an account holder with an intuitive and informative depiction of financial transactions to enable the account holder to readily identify inconsistencies in a statement of account activity. Additionally, the consumer can use the depiction of financial transactions to gain insight into certain patterns of financial transactions.

The preferred embodiments can monitor financial transaction activity of an account holder to keep track of the financial transaction entered into by the account holder. The financial institution can collect transaction information related to the transactions. Such information can include a purchase amount, a purchase time, a purchase location, a merchant name, a merchant category, etc. The transaction information associated with the transaction can be mapped to correlate the consumer's transaction activity with a selected parameter, such as time, amount, location, type of transaction, etc. The mapping can be depicted to the account holder via a print out or a display.

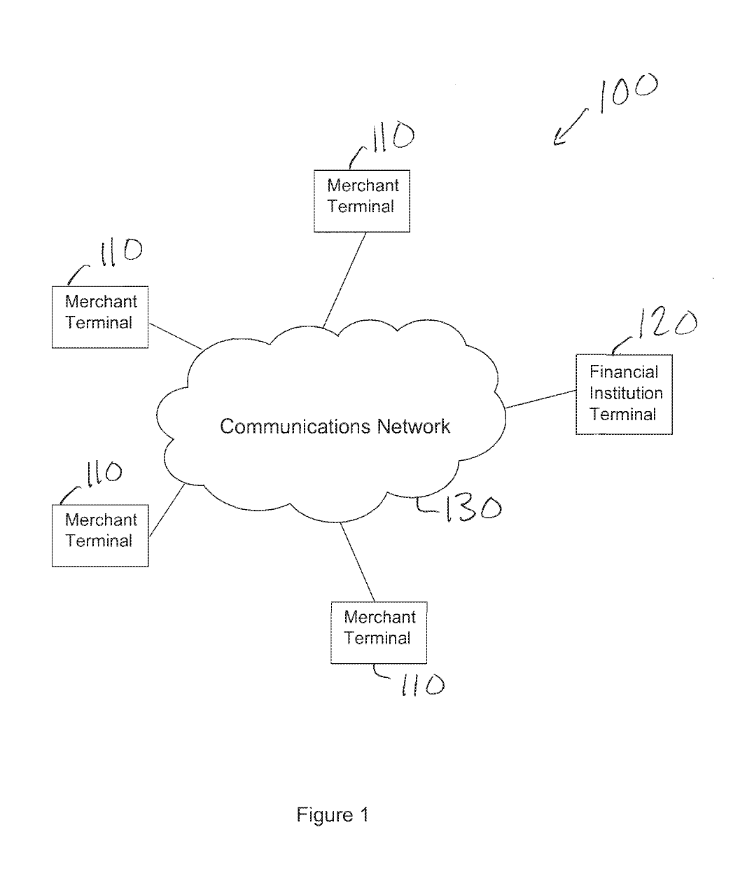

FIG. 1 depicts a financial transaction system that preferably includes merchant terminals 110, one or more financial institution terminals 120, and communication network 130, such as a public switched telephone network (PSTN), virtual private network (VPN), Internet, or the like. The merchant terminals 110 can represent devices that read account information from a customer's transaction device. Merchants that use the merchant terminals 110 may, for example, sell goods or services. The merchant terminals 110 can be dispersed throughout the world according to the geographic location(s) of the merchants.

The one or more financial terminals 120 can receive, collect, and maintain information associate with account holders. Such information can include, but is not limited to an account number, a credit limit, an amount of money due, an address of the account holder, transaction information for purchase made by the account holder. The financial institution can use this information when determining whether to authorize payment for the goods or services that account holder wishes to purchase.

In a financial transaction, the account holder/customer wishes to purchase an item from a merchant. The merchant obtains information from the account holder's transaction device using the merchant terminal 110. The information is then transmitted to the financial institution terminal 120 for authorization of the sale. The account holder is either billed for the purchase in his next statement or funds from the account holder's account are disbursed.

The financial terminal 120 collects transaction information associated with the purchase and stores the information either locally or remotely. The transaction information can include a purchase date and time, a purchase amount, a merchant name, merchant category, and a merchant location (including street number, address, city, state, country, or the like). The financial institution uses the transaction information when it generates a statement of purchases to be viewed by the account holder. The one or more financial terminals can be implemented in a central or distributed manner such that the transaction information and other account information can be in different locations.

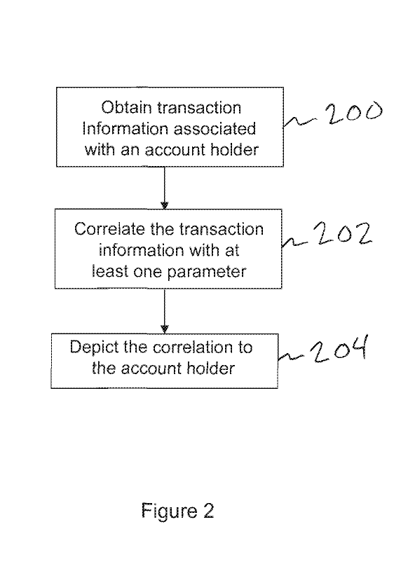

FIG. 2 is a flow chart that illustrates generating a statement of purchases in accordance with the preferred embodiments of the present invention. A statement generator obtains transaction information associated with an account holder (step 200). The transaction information can include purchase dates and times, purchase amounts, merchant names, merchant categories, and merchant locations, or the like. As such, the statement generator can obtain transaction information for purchases made by the account holder during the statement period.

Subsequently, the statement generator can correlate the transaction information with at least one parameter (step 202). The parameters can include dates and times, amounts, names, merchant categories, and locations, or the like. For example, the statement generator can correlate the transaction information with a geographic location so that the transaction information can be plotted on a map that includes the geographical location. The correlation between the transaction information and the at least one parameter can be included in an extensible markup language (XML) representation or other representations known to those skilled in the art.

Upon the correlation of the transaction information and the at least one parameter, the statement generator can render the correlation graphically to the account holder so that the transaction information is depicted with reference to the at least one parameter (step 204). The depiction can be on a display, print out, or any other suitable medium. The depiction can provide a graphical representation of the transaction information so that the account holder can view the graphical representation and discern transaction information relating to purchases made by the account holder.

In some embodiments, the graphical representations can be used to implement promotions and incentives. The graphical representations can depict, for example, merchants, located in proximity to a purchase location, from which the account holder can receive discounts, coupons, or incentives on future purchases. In addition, or alternatively, the graphical representations can identify certain rewards, such as gift certificates, for future purchases in a selected geographic region and/or during a selected time period.

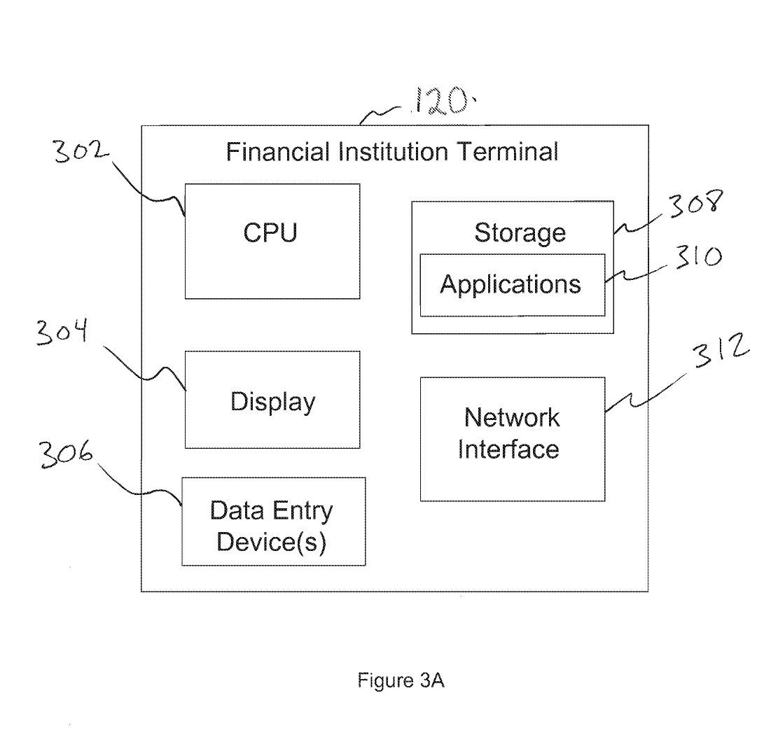

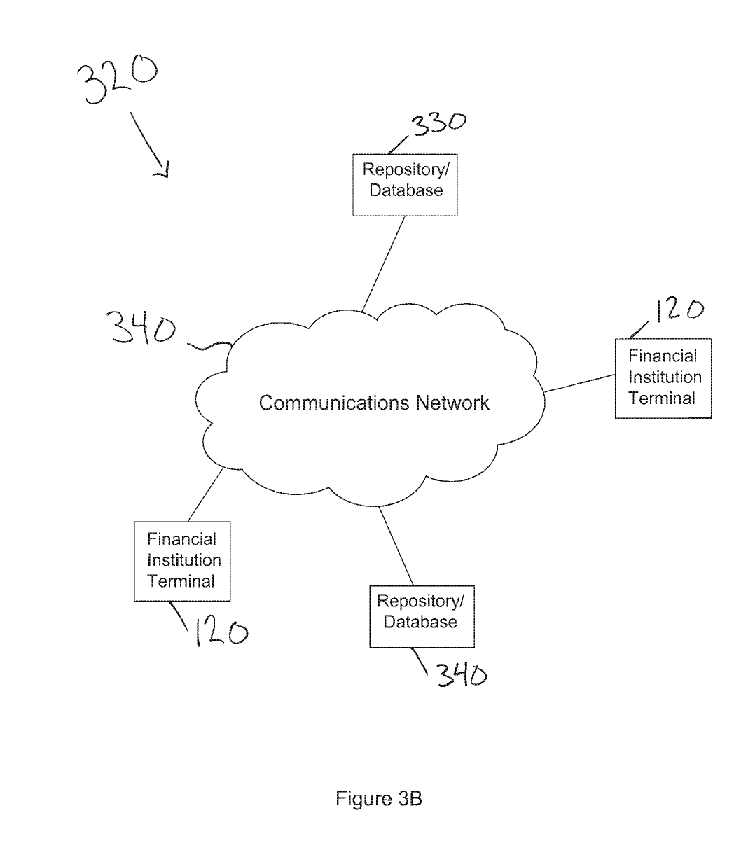

FIG. 3A depicts an exemplary financial institution terminal 120 for implementing the statement generator in accordance with the preferred embodiment of the present invention. The financial institution terminal 120 can be a mainframe, personal computer (PC), laptop computer, workstation, handheld device, such as a PDA, or the like. In the illustrated embodiment, the financial institution terminal 120 includes a central processing unit (CPU) 302 and preferably a display device 304. The display device 304 enables the financial institution terminal 120 to communicate directly with a user through a visual display. The financial institution terminal 120 can further include data entry device(s) 306, such as a keyboard, touch screen, and/or mouse. The financial institution terminal 120 can include storage 308 for storing data, such as transaction information, other account information, and parameters; and instructions, such as instruction for generating a statement. The storage 308 can include such technologies as a floppy drive, hard drive, tape drive, Flash drive, optical drive, read only memory (ROM), random access memory (RAM), and the like.

Applications, such as the statement generator 310 for performing the process described above, can be resident in the storage 308. The storage 308 can be local or remote to the financial institution terminal 120. The financial institution terminal 120 includes a network interface 312 for communicating with a network and can be used for a distributed implementation. The CPU 302 operates to run the application in storage 308 by performing instructions therein and storing data resulting from the performed instructions, which may be depicted via the display 304 or by other mechanisms known to those skilled in the art, such a print out from a printer.

The statement generator 310 generates a graphical representation associated with purchases as discussed above. The statement generator 310 can include code known to those skilled in the art that when executed can generate the graphical representations described herein. The code can be composed of at least one of C, C++, Java, Basic, Perl, assembly language, machine code, or the like.

FIG. 3B depicts a distributed system 320 for implementing the generation of a statement of purchases. The distributed system includes one or more financial institution terminal 120 and preferably includes one or more repositories or database 330, which can be in communication with each other via a communications network 340. The one or more repositories/databases 330 can store information, such as the transaction information or other account information. The financial institution terminal 120 can implement the statement generator and retrieve the transaction information, parameters, and/or account information from the one or more repositories/databases 330. Likewise data generated by the statement generator, such as the correlation between the transaction information and at least one of the parameters and/or the graphical representation that is generated based on the correlation can be stored in the one or more repositories/databases 330.

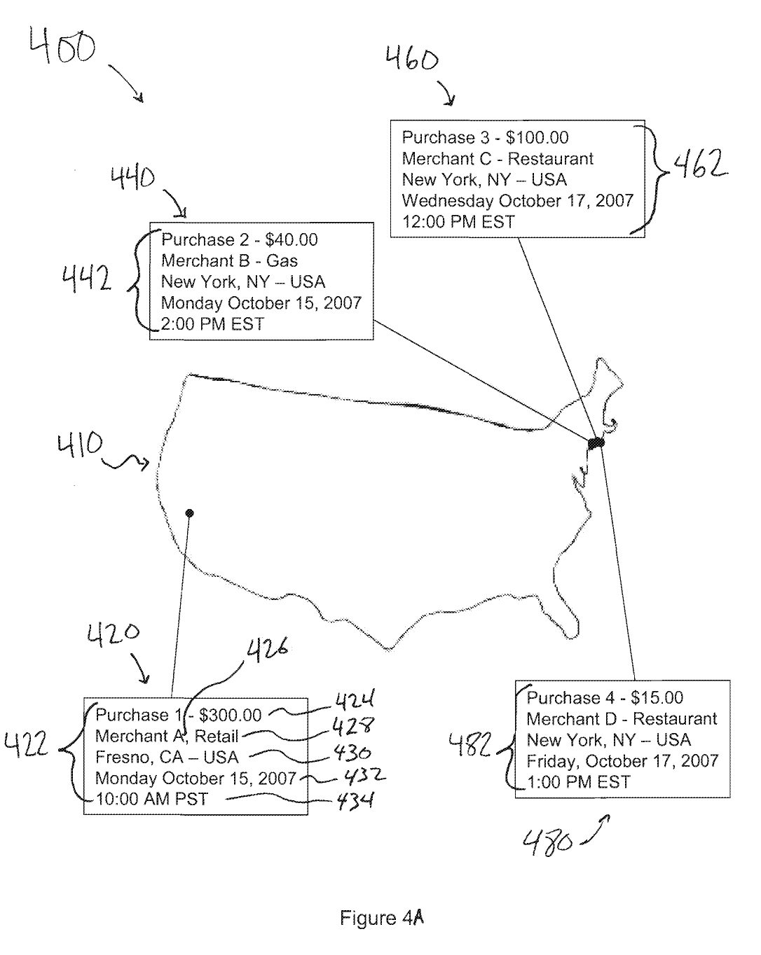

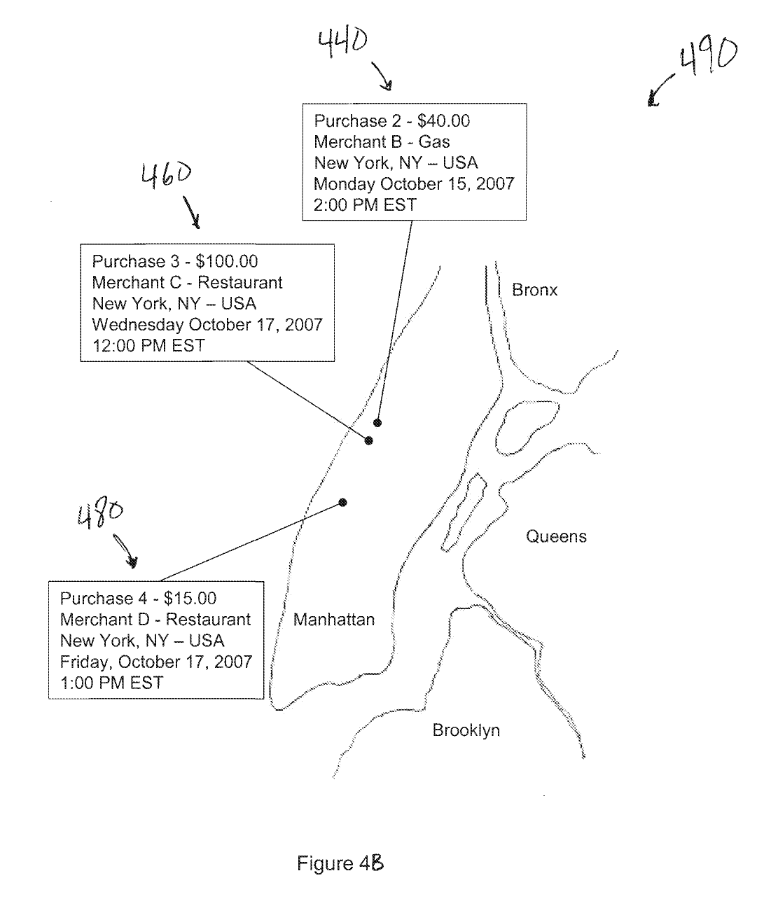

FIGS. 4A-B are exemplary graphical representations of the statement of purchases that can be generated using the statement generator 310 in accordance with the preferred embodiments of the present invention. Referring to FIG. 4A, a graphical representation 400 depicts the transaction information associated with purchases made by an account holder. In the present example, the graphical representation 400 depicts transaction information with reference to location. A map 410 can represent a geographical area in which the account holder made purchases. The geographical areas depicted can depend on the location at which the account holder made the purchases. For example, the map 410 may depict the world, one or more continents, countries, states or provinces, cities, towns, villages, etc.

Still referring to FIG. 4A, the purchase made by the account holder can be marked on the map 410 so that the account holder can view the relationship between purchases made and the locations. In this example, the account holder made a purchase 420, a purchase 440, a purchase 460, and a purchase 480. The purchase 420 is marked on the map at the location where the purchase was made. Transaction information 422, 442, 462, and 482 associated with the purchases 420, 440, 460, and 480, respectively, can be depicted in the graphical representation 400. For example, a purchase amount 424, merchant name 426, merchant category 428, purchase location 430, purchase data 432, and/or a purchase time 434 can be depicted for the purchase 420.

Upon viewing the graphical representation 400, the account holder can readily discern that while the majority of the purchases occurred in New York, there is a purchase that occurred in California. The account holder can then determine if any purchases were made in California having the transaction information 422. In this case the purchase 420, occurring in California, occurred on the same date and at about the same time as the purchase 440 in New York. Such a purchase may have occurred via the internet where the merchant was located in California. If no purchases were made at the California merchant location, the account holder can notify the financial institution of an unauthorized and/or fraudulent purchase.

Referring to FIG. 4B, a graphical representation 490 depicts the transaction information associated with purchases made by an account holder within a geographical area of a city. As indicated, transaction information for purchases 440, 460, and 480 is provided in this view to identify purchases made within the geographical area of the city. In embodiments where the graphical representations (e.g., graphical representations 400 and 490) are depicted on a display, the graphical representations may include interactive features. For example, the graphical representations can be depicted using a graphical user interface (GUI) generated by code included in the statement generator 310 that allows the account holder to zoom in or zoom out to view transaction information associated with purchases at the world, continent, country, state, province, city, town, village, and the like. The GUI can allow the account holder to select a purchase (e.g., purchase 420, 440, 460, or 480) to view more information about the purchase. For example, the graphical representations can include transaction information related to the purchase amount. To view addition transaction information, the account holder can select the purchase to view additional transaction information. In addition, or in the alternative, the user can select a purchase and can be directed to a website associated with the merchant from which the account holder made the purchase.

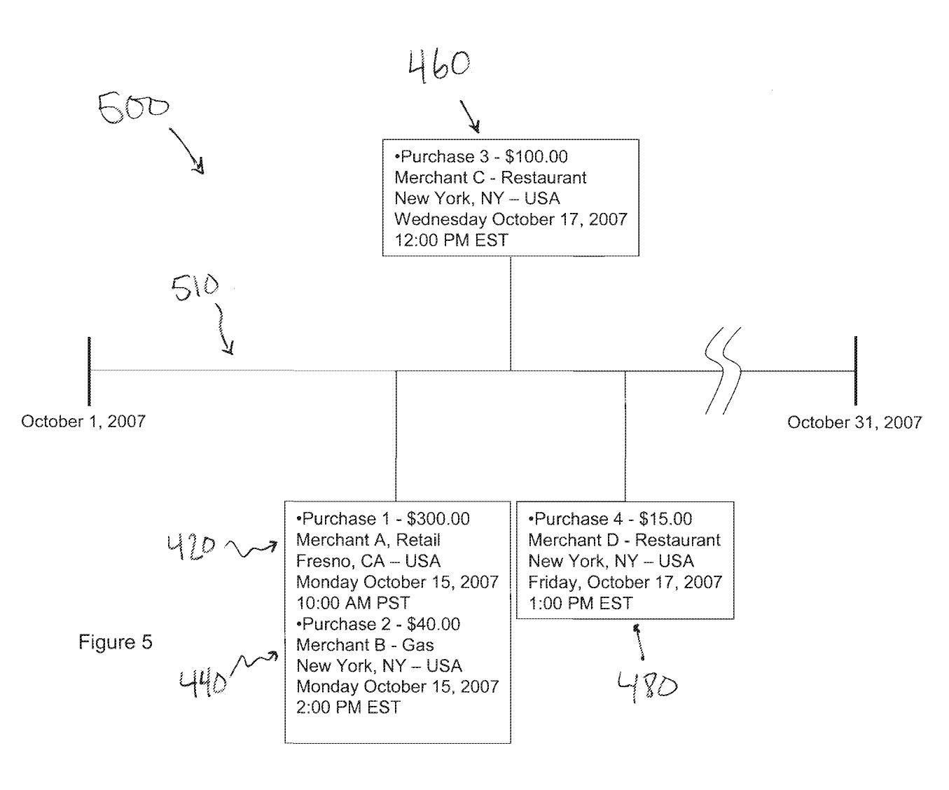

FIG. 5 is a graphical representation 500 of the statement of purchases that can be generated in accordance with the preferred embodiments of the present invention. The graphical representation 500 generated by the statement generator is in the form of a time line 510, which represents a statement period. Purchases 420, 440, 460, and 480 can be distributed along the time line 510 based on when the purchases were made. The transaction information (e.g., transaction information 422, 442, 462, and/or 482) can be depicted in the graphical representation 500.

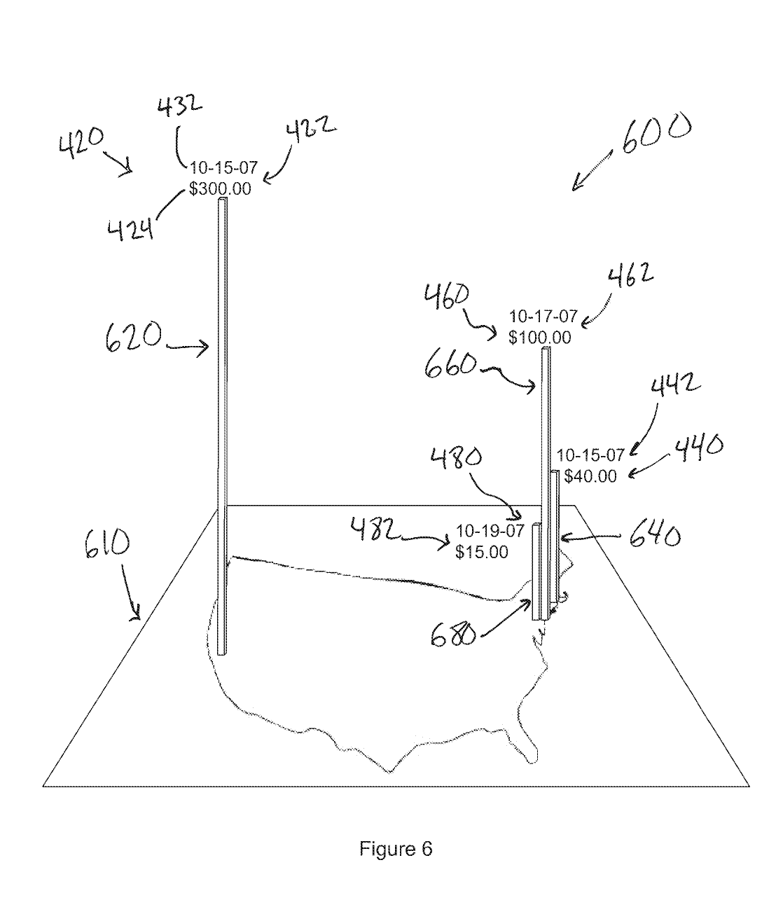

FIG. 6 is an exemplary depiction of a graphical representation 600 of the statement of purchases that can be generated in accordance with the preferred embodiments of the present invention. The graphical representation 600 generated by the statement generator can be a three dimensional (3D) shape that includes a map 610 and purchases 420, 440, 460, and 480. The graphical representation 600 can present one or more components of the transaction information graphically using, for example, 3D bars 620, 640, 660, and 680. In this example, the 3D bars can represent a purchase amount for the purchases and can be sized to be proportional to the purchase amount. Some, all, or none of the transaction information 422, 442, 462, and/or 482 can be used to annotate the bars. For example, the purchase amount 424 and the purchase date 432 can be depicted.

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method of presenting transaction information comprising:
retrieving transaction information for past financial transactions associated with an account holder from a storage medium;
correlating the transaction information with at least one parameter using a statement generator implemented by one or more financial institution terminals; and
depicting the transaction information and the at least one parameter graphically to the account holder by the statement generator based on the correlating to identify a relationship between the past financial transactions using a visual diagram.

2. The method of claim 1, wherein the depicting comprises generating a print out of the correlation.

3. The method of claim 1, wherein the depiction comprises rendering the correlation on at least one of geographic map being depicted on a on a display and a time line being depicted on a on a display.

4. The method of claim 1, wherein the transaction information includes at least one of a purchase amount, a purchase location, a purchase time, or a purchase category.

5. The method of claim 1, wherein the at least one parameter includes at least one of a purchase location, a purchase time, a purchase amount, or a purchase category.

6. The method of claim 1, wherein depicting the transaction information and the at least one parameter graphically to the account holder by the statement generator based on the correlating to identify a relationship between the past financial transactions using a visual diagram comprises forming a three dimensional (3D) shape to depict the relationship between the financial transactions.

7. The method of claim 1, wherein correlating the transaction information comprises correlating a purchase amount to a location to graphically identify the location of a purchase.

8. The method of claim 1, wherein correlating the transaction information comprises correlating a purchase amount to a time value to graphically identify a time of a purchase.

9. The method of claim 1, further comprising detecting a fraudulent purchase based on the correlation.

10. The method of claim 1, wherein the depicting further comprising identifying at least one of a promotion, discount, or incentive associated with a purchase.

11. A computer readable medium storing instructions executable by a computing device to implement a method of graphically representing at least one financial transaction, the method comprising:
retrieving transaction information for past financial transactions associated with an account holder from a storage medium;
correlating the transaction information with at least one parameter using a statement generator implemented using one or more financial institution terminals; and
depicting the transaction information and the at least one parameter graphically to the account holder by the statement generator based on the correlating to identify a relationship between the past financial transactions using a visual diagram.

12. The medium of claim 11, wherein the depicting comprises generating a print out of the correlation.

13. The medium of claim 11, wherein the depiction comprises rendering the correlation on at least one of geographic map being depicted on a display and a time line being depicted on a on a display.

14. The medium of claim 11, wherein the transaction information includes at least one of a purchase amount, a purchase location, a purchase time, or a purchase category.

15. The medium of claim 11, wherein the at least one parameter includes at least one of a purchase location, a purchase time, a purchase amount, or a purchase category.

16. The medium of claim 11, wherein depicting the transaction information and the at least one parameter graphically to the account holder by the statement generator based on the correlating to identify a relationship between the past financial transactions using a visual diagram comprises forming a three dimensional (3D) shape to depict the relationship between the financial transactions.

17. The medium of claim 11, wherein correlating the transaction information comprises correlating a purchase amount to a location to graphically identify the location of a purchase.

18. The medium of claim 11, wherein correlating the transaction information comprises correlating a purchase amount to a time value to graphically identify a time of a purchase.

19. The medium of claim 11, further comprising detecting a fraudulent purchase based on the correlation.

20. A system for generating a graphical representation of financial transaction comprising:
storage for storing transaction information for past financial transactions associated with an account holder;
a statement generator for generating a graphical representation based on the transaction information associated with an account holder and at least one parameter, where the statement generator correlates the transaction information with the at least one parameter and depicts the transaction information and the at least one parameter based on the correlation to identify a relationship between the past financial transactions using a visual diagram.

21. The system of claim 20, wherein the statement generator depicts the graphical representation as at least one of a print out or a display of the correlation.

22. The system of claim 20, wherein the transaction information includes at least one of a purchase amount, a purchase location, a purchase time, or a purchase category and the at least one parameter includes at least one of a purchase location, a purchase time, a purchase amount, or a purchase category.

23. The system of claim 20, wherein the statement generator correlates a purchase amount to a location to graphically identify a location of a purchase.

24. The system of claim 20, wherein the statement generator correlates a purchase amount to a time value to graphically identify a time of a purchase.

25. The system of claim 20, wherein the storage is remote to the statement generator.
